(19) United States
(12) Patent Application Publication
(10) Pub. No.: US 2007/0060472 A1
(43) Pub. Date: Mar. 15, 2007

(54) Manganese ozone decomposition catalysts and process for its preparation

(75) Inventors: Janet Mary Fisher, Reading (GB); Hazel Margaret Anne Hunter, Cambridge (GB); Christopher Gough Morgan, Royston (GB); David Thompsett, Reading (GB)

Correspondence Address: RATNERPRESTIA, P O BOX 980, VALLEY FORGE, PA, 19482-0980, US

(73) Assignee: JOHNSON MATTHEY PUBLIC LIMITED COMPANY, LONDON (GB)

(21) Appl. No.: 10/555,135

(22) PCT Filed: Apr. 29, 2004
(86) PCT No.: PCT/GB04/01839

§ 371 Date: Nov. 6, 2006

(30) Foreign Application Priority Data
Apr. 29, 2003 (GB) 0309752.4

(51) Int. Cl. B01J 23/34; B01J 23/32; B01J 21/00

(52) U.S. Cl. 502/232; 502/324; 502/234; 502/235; 502/236; 502/237; 502/238; 502/239

(57) ABSTRACT

A method of making an ozone decomposition catalyst comprising an amorphous metal oxide consisting of manganese and, optionally, one or more of zirconium, silicon, titanium and aluminium, on a particulate support material, comprises the steps of preparing a mixture comprising an aqueous manganese salt and the support material and co-precipitating the metal oxide onto the support material.

The present invention relates to catalysts for decomposing ozone, and in particular it relates to catalysts for decomposing ozone at temperatures of up to about 150° C.

Numerous materials have been reported in the literature to be active for the catalytic decomposition of ozone. These include moisture (H₂O), silver, platinum, manganese dioxide, sodium hydroxide, soda lime, bromine, chlorine and nitrogen pentoxide (source: Encyclopaedia of Chemical Technology, First Edition, Vol. 9, p. 736, Ed. R. E. Kirk & D. F. Othmer, The Interscience Encyclopaedia, Inc., New York (1952)). Of these, manganese dioxide is particularly prominent.

U.S. Pat. No. 4,871,709 explains that manganese oxide is conventionally well known as a catalyst for catalytically cracking ozone, and that various methods for producing the catalyst have been developed. One such prior art method referenced is described in JP 51-71299, wherein an active manganese dioxide is obtained by adding potassium permanganate to an acidic aqueous solution of a manganese salt and ageing the solution. The ozone cracking catalyst claimed in U.S. Pat. No. 4,871,709 comprises active manganese oxide carried on an aggregate of ceramic fibres obtainable by dipping the aggregate in a manganous nitrate solution, exposing the dipped aggregate to an ammonia-rich gas stream to convert the Mn(NO₃)₂ to Mn(OH)₂ and then drying and calcining the resulting aggregate in air. A catalyst made according to a method described in the patent results in active manganese oxide comprised of microparticles of amorphous manganese oxide according to X-ray diffraction analysis.

Methods of making active manganese dioxide are also described in a chapter by Alexander J. Fatiadi in “Organic Synthesis by Oxidation with Metal Compounds”, Ed. W. J. Mijs and C. R. H. I. de Jonge, Plenum Press, New York (1986). These include a procedure described by Mancera, Rosenkranz and Sondheimer, J. Chem Soc., 2189 (1952) in which the active material is precipitated from a mixture of warm, aqueous solution of manganese sulfate and potassium permanganate in acidic conditions—the same method described in U.S. Pat. No. 4,871,709 and JP 51-71299. Attenburrow, Cameron and Chapman et al. J. Chem Soc., 1094 (1952) is also referenced and describes a similar method requiring alkaline conditions instead of acidic conditions.

A similar method in which warm potassium permanganate solution is added to a solution of manganese sulfate solution acidified with acetic acid is described in “The synthesis of birnessite, cryptomelane, and some other oxides and hydroxides of manganese” by R. M. McKenzie, Minerological Magazine, Vol. 38, pp. 493-502 (December 1971). Cryptomelane (α-MnO₂) is said to result

U.S. Pat. No. 5,340,562 describes a process for synthesising synthetic manganese oxide hydrates having various structures including hollandite and todorokite by hydrothermal synthesis. Similar to the methods described above, the processes comprise reacting a soluble manganous salt and a permanganate under conditions of temperature, pressure and pH effective to produce the desired manganese oxide hydrates. The manganous salt can be the sulfate, nitrate, perchlorate or a salt of an organic acid, such as the acetate, with the sulfate, nitrate and acetate salts preferred.

WO 96/22146 describes certain methods of making high surface area cryptomelane, referencing U.S. Pat. No. 5,340,562 and the above McKenzie paper. These methods include precipitating the materials by adding a warmed aqueous solution of manganous sulfate and acetic acid or manganous acetate and acetic acid to a warmed solution of potassium permanganate. The document mentions that it is known to use the cryptomelane form of α-MnO₂ to catalyse the decomposition of ozone.

JP 4007038 discloses an ozone decomposition catalyst comprising an amorphous manganese dioxide and a zeolite coated on a monolithic honeycomb support for use in removing ozone in water and sewage treatment, sterilisation, treatment of industrial effluent, denitration and deodorisation of flue gas and treatment of corona discharge in electrophotographic equipment However, the present inventors consider the disclosure non-enabling: in the Working Examples, a manganese dioxide paste containing 40% amorphous manganese dioxide is mentioned without reference to where or how it was obtained.

EP 0367574 discloses a binary MnO₂—TiO₂ ozone decomposition catalyst obtainable by co-precipitation.

We have investigated the materials described in the prior art and have developed a family of novel supported manganese-containing catalysts for ozone decomposition with comparable activity to prior art catalysts and which contain substantially less manganese.

According to a first aspect, the invention provides a method of making an ozone decomposition catalyst comprising an amorphous metal oxide consisting of manganese and, optionally, one or more of zirconium, silicon, titanium and aluminium, on a particulate support material, which method comprising the steps of preparing a mixture comprising an aqueous manganese salt and the support material and co-precipitating the metal oxide onto the support material.

According to one embodiment, the amorphous manganese oxide is obtainable by comproportionation of at least two oxidation states of manganese.

According to another embodiment, the method comprises mixing a first aqueous solution of a permanganate salt and a second aqueous solution of a manganous salt, wherein the support material is in either the first solution or the second solution or both.

The first solution or the second solution or both can contain a soluble base material, which can be potassium hydroxide, sodium hydroxide or a tetra-alkyl ammonium hydroxide, for example.

Alternatively, the first solution and/or the second solution can contain an acid which can be sulfuric acid, nitric acid, hydrochloric acid or a carboxylic acid, preferably acetic acid.

The manganous salt for use in the method according to the invention can be manganese chloride (MnCl₂), manganese nitrate (Mn(NO₃)₂), manganese sulfate (MnSO₄), manganese perchlorate or a manganese carboxylate, preferably manganese acetate (Mn(CH₃COO)₂) or a mixture of any two or more thereof.

The permanganate salt for use in the above embodiment can be a salt of an alkali metal or an alkaline earth metal, such as a permanganate salt of sodium, potassium, caesium, magnesium, calcium or barium or a mixture of any two or more thereof. However, potassium permanganate is preferred because it is widely available and relatively cheap.

According to another embodiment, the amorphous metal oxide comprises at least 50 mole % manganese, such as from 50-95 mole % manganese. Illustrative embodiments of such amorphous metal oxides include Mn85:Zr15, Mn85:Ti15, Mn66:Ti33 or Mn85:Al15, each relative to the number of moles of manganese.

In our investigations, we observed that for supported manganese oxides, binary composite oxide materials and binary mixed oxide materials, generally the more manganese that was present, the more active the catalyst was at converting ozone. However, when we tested the supported Mn66:Ti33 we found that it was more active than the supported Mn85:Ti15. Hence, the indication is that some sort of synergy exists between Mn and Ti, the mechanism of which is as yet not fully understood.

We have found that the manganese in the oxide material is partially present in the +3 oxidation state, and we believe that this contributes to the particular activity of the material for use in the method. Details of XRD analysis of the amorphous metal oxide are included in the Examples.

Early indications are that an acidic support may improve catalyst activity. Accordingly, suitable support materials for use in the method of the invention include alumina (such as gamma, delta or theta), silica, zirconia, titania, ceria, chromia or a mixture, mixed oxide or composite oxide of any two or more thereof.

“Composite oxide” as defined herein means a largely amorphous oxide material comprising oxides of at least two elements which are not true mixed oxides consisting of the at least two elements.

The support material can include a dopant to improve the properties of the support material such as to achieve and maintain a high surface area. Such dopant can include lanthanum, barium, cerium, aluminium, titanium, tungsten, silica and manganese. By “dopant” herein, we mean present in an amount of up to 25 mol %.

Alternative support materials include boehmite (aluminium hydroxide) and activated carbon, although activated carbon-containing catalysts are not true catalysts since the carbon is itself combusted in the ozone decomposition.

Another class of support material suitable for use in the invention is molecular sieves, such as zeolites, hydrotalcites, silica-based mesoporous materials, iron oxide-based mesoporous materials, aluminium phosphonates, ion exchange resins and mixtures of any two or more thereof. The preferred molecular sieve is the zeolite, preferred members of which are ZSM-5, Y-zeolite and β-zeolite, or mixtures thereof. Zeolites are particularly preferred because we have found that it is possible to remove atmospheric pollutants such as hydrocarbons as well as ozone in a redox reaction by adsorbing the hydrocarbons on a precious metal-free zeolite and then contacting the hydrocarbon/zeolite with ozone. Such method is described in our WO02/92197.

Further support materials useful in the method according to the invention comprise any of the following as mixed oxides or composite oxides: amorphous silica-alumina, silica-zirconia, alumina-zirconia, alumina-chromia, alumina-ceria, ceria-titania, manganese-zirconia, manganese-alumina, manganese-silica, manganese-titania and ternary or quaternary mixed oxide or composite oxide materials comprising manganese and at least two of zirconium, aluminium, silicon and titanium and mixtures of any two or more thereof.

In one embodiment, where the support material is silica-alumina or silica-zirconia, desirably it comprises from 1% to 35% by weight of silica and from 65% to 99% by weight of M, wherein M is alumina or zirconia.

In another embodiment, manganese-containing support materials can comprise at least 50 mole % manganese, preferably 50-95 mole % manganese.

As mentioned above, we have found that high surface areas are important for optimal ozone decomposition activity. Generally, the surface area of the catalyst is a function of the surface area of the support. In embodiments according to the invention, the surface area of the support material is from 50 to 700 m²/g, such as 100 to 450 m²/g or 150 to 400 m²/g.

For optimal activity, it is desirable for the particle size D90 of the support material to be in the range of from 0.1 to 50 μm, such as up to 20 μm or 10 μm.

According to a second aspect, the invention provides an ozone decomposition catalyst obtainable by the method according to the first aspect of the invention.

In one embodiment, catalysts according to the invention comprise at least one precious metal on the support. Such at least one precious metal can be selected from platinum group metals, silver and gold. The or each at least one platinum group metal may be selected from platinum, palladium and rhodium, and is preferably platinum or palladium. Precious metal concentration can be from 0.1-20 wt % total precious metal, such as 0.5-15 wt % or 2-5 wt %. However, in a preferred embodiment, the catalyst contains no precious metals at all.

In order to achieve improved ozone conversion it can be desirable to include at least one catalyst promoter selected from copper, iron, zinc, chromium, nickel, cobalt and cerium on the support By “promoter” herein, we mean present in an amount of up to 10 wt %.

According to a third aspect, the invention provides a catalyst composition comprising a catalyst according to the invention and a binder.

In one embodiment, the binder can be inorganic, such as silicate-based, alumina-based or ammonium zirconium carbonate-based, or it can be organic.

Where the binder is organic it can be any of the binders described in WO 96/22146, i.e. polyethylene, polypropylene, a polyolefin copolymer, polyisoprene, a polybutadiene copolymer, chlorinated rubber, nitrile rubber, polychloroprene, an ethylene-propylene-diene elastomer, polystyrene, polyacrylate, polymethacrylate, polyacrylonitrile, a poly(vinyl ester), a poly(vinyl halide), a polyamide, an acrylic, a vinyl acrylic, an ethylene vinyl acetate copolymer, a styrene acrylic, a poly vinyl alcohol, a thermoplastic polyester, a thermosetting polyester, a poly(phenyleneoxide), a poly(phenylene sulfide), a fluorinated polymer, a poly(tetrafluoroethylene), polyvinylidene fluoride, poly(vinylfluoride), a chloro/fluoro copolymer, ethylene, a chlorotrifluoroethylene copolymer, a polyamide, a phenolic resin, an epoxy resins, polyurethane, a silicone polymer or a mixture of any two or more thereof.

We have obtained particularly good results using an ethylene vinyl acetate copolymer, as described in Example 10.

The binder can be used in any suitable solids weight ratio relative to the catalyst, such as a catalyst:binder of from 15:1 to 1:5, preferably from 10:1 to 1:1. Example 10 uses a catalyst:binder ratio of 2:1.

According to a fourth aspect, the invention provides an atmosphere contacting surface coated with a catalyst composition according to the invention. Methods of coating are known in the art and include waterfall, electrostatic spray coating and air-assisted and air-less spray coating techniques.

According to one embodiment, the atmosphere contacting surface comprises a heat exchanger, which can be a radiator, an air charge cooler, an air conditioner condenser, an engine oil cooler, a power steering oil cooler or a transmission oil cooler. Generally the operating temperature of such coolers will be at up to 150° C., such as from 40-130° C. and typically at up to 110° C.

According to a fifth aspect, the invention provides a vehicle or a non-vehicular device comprising an atmosphere contacting surface according to the invention.

In a particular embodiment of the invention, the atmosphere-contacting surface is on a vehicle, such as a motor vehicle. The broad concept of applying an ozone treating catalyst to, for example, a motor vehicle radiator for treating atmospheric pollutants such as ozone and carbon monoxide was first described in DE 4007965.

Alternatively, the atmosphere-contacting surface can form part of a non-vehicular device or apparatus. In one embodiment, it comprises a component of a moving advertising hoarding or an air-conditioning system for a building, such as ducting, grills or fan blades e.g. for drawing air into the air conditioning system and/or circulating air within the system.

In another embodiment, the atmosphere contacting surface is a fan blade, a fan grill or a conduit for conveying a fluid of a powered tool such as a lawnmower, a cutter, a strimmer, a disk saw, a chain saw or a leaf blower/collector.

According to a sixth aspect, the invention provides a method of decomposing ozone, which comprises contacting a fluid containing the ozone with a catalyst according to the invention, preferably at up to 150° C. According to one embodiment, the fluid is atmospheric air.

In order that the invention may be more fully understood, the following Examples are provided by way of illustration only with reference to the accompanying drawings, in which:

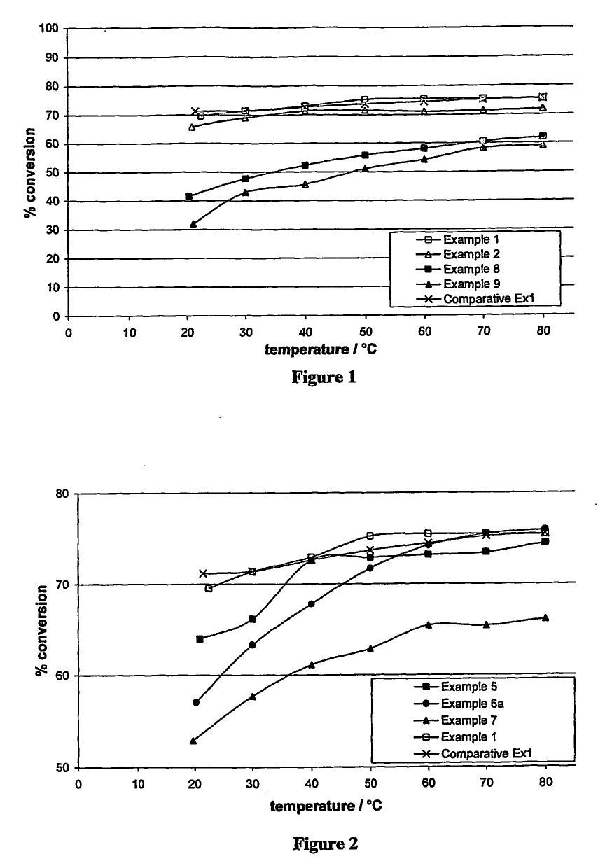

FIGS. 1, 2 and 3 are graphs showing % conversion of ozone over a radiator spot coated with catalyst compositions according to the invention in a gas containing 100 ppb ozone at a flow rate of 1.3 metres sec⁻¹;

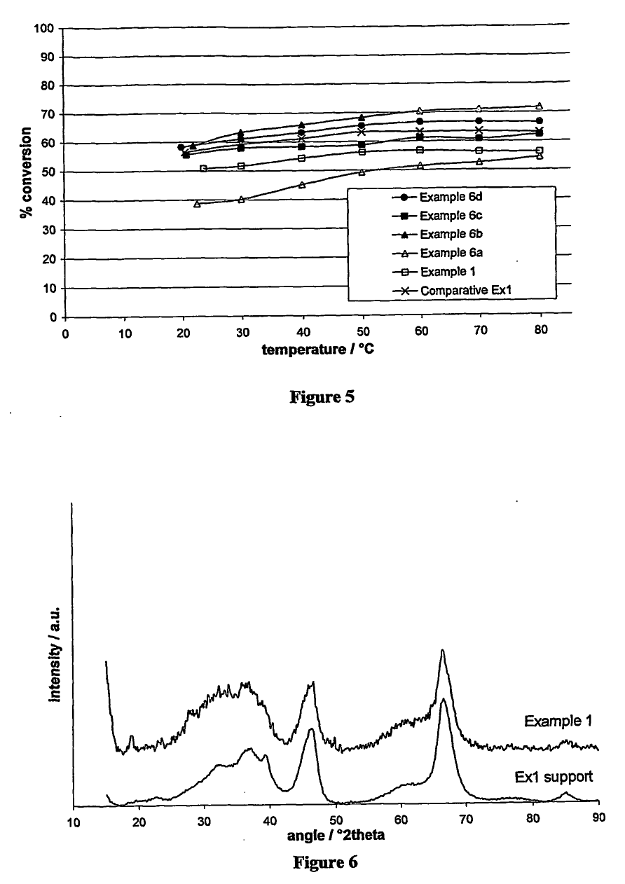

FIGS. 4 and 5 are graphs showing % conversion of ozone over a radiator spot coated with catalyst compositions according to the invention in a gas containing 100 ppb ozone at a flow rate of 5.0 metres sec⁻¹;

FIG. 6 shows the XRD pattern for the Example 1 material and the support material per se;

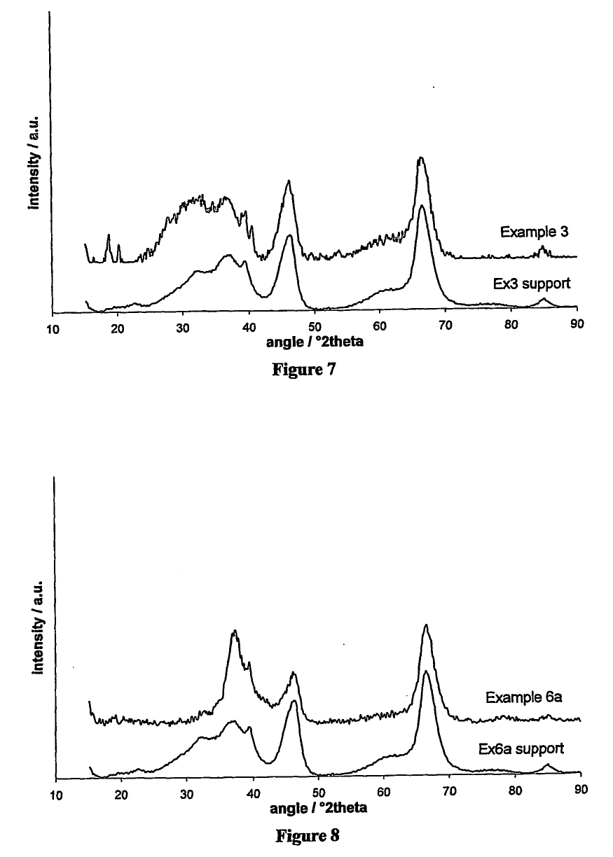

FIG. 7 shows the XRD pattern for the Example 3 material and the support material per se;

FIG. 8 shows the XRD pattern for the Example 6a material and the support material per se;

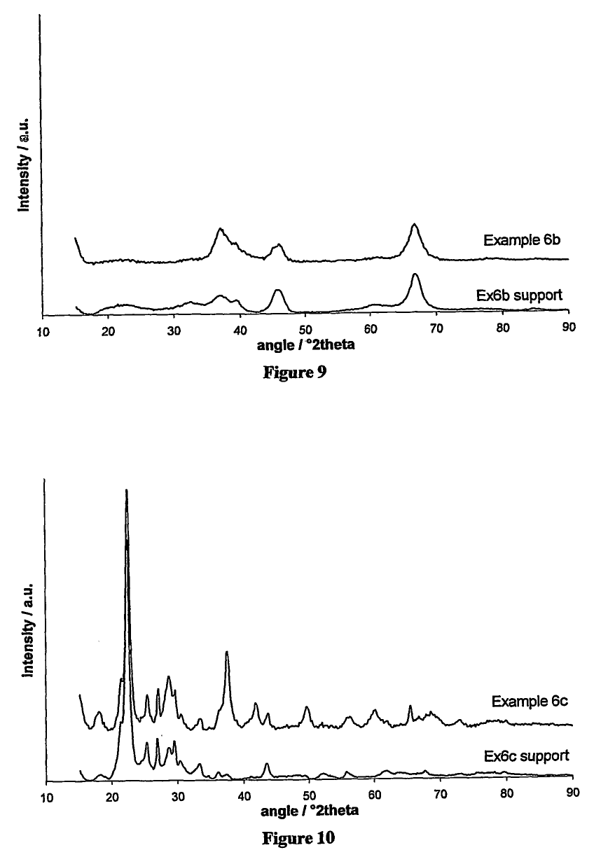

FIG. 9 shows the XRD pattern for the Example 6b material and the support material per se;

FIG. 10 shows the XRD pattern for the Example 6c material and the support material per se;

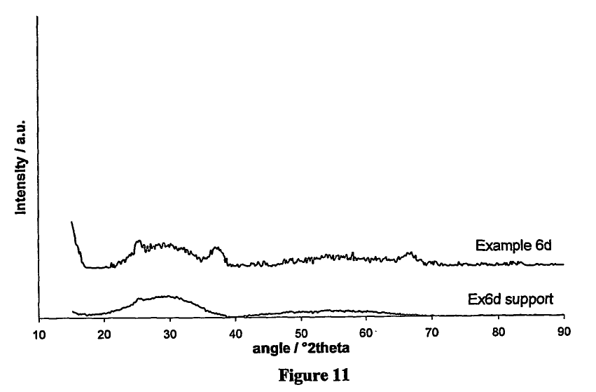

FIG. 11 shows the XRD pattern for the Example 6d material and the support material per se;

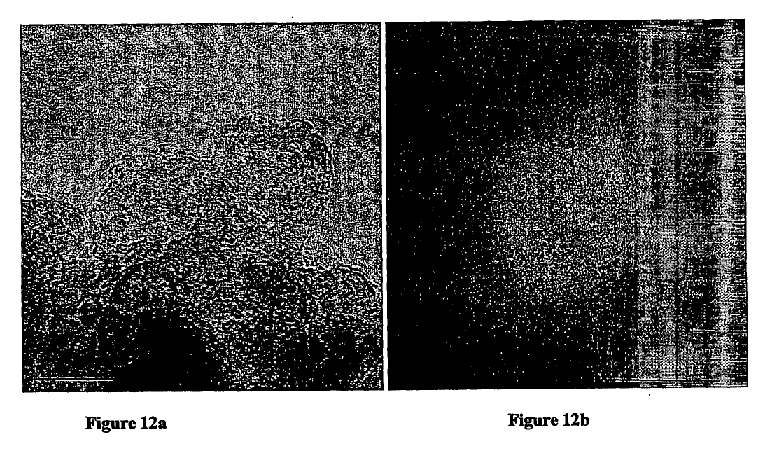

FIG. 12a (left hand side) shows a bright field transmission electron microscope (GEM) mage of a fresh area of clustered Example 1 particles, with its associated fast fourier transform (FFT) electron diffraction pattern FIG. 12b (right-hand side); and

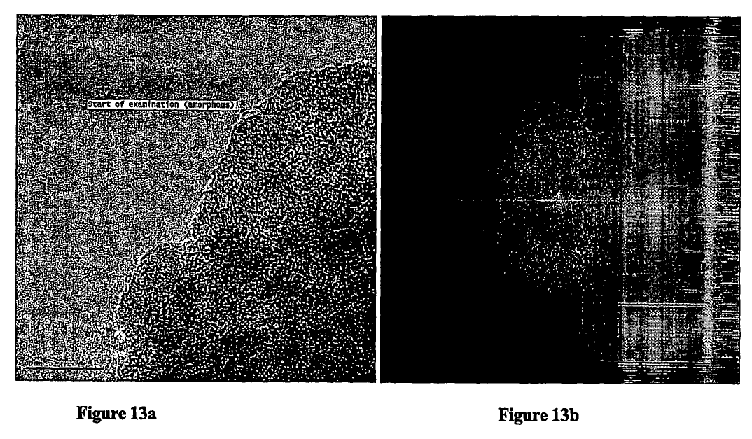

FIG. 13a (left hand side) shows a bright field TEM image of a fresh area of clustered Example 3 particles, with its associated FFT electron diffraction pattern FIG. 13b (right-hand side).

### EXAMPLE 1

### Supported Amorphous Mn:Ti 66:33

Jet-milled gamma alumina (1) (82 g) was slurried in water (500 ml) in a 2 L beaker. Manganese nitrate 50% w/w solution (118.8 g, 0.332 mol) and titanium oxychloride (34 ml, 396 gl⁻¹ TiO₂, 0.167 mol) were mixed (black precipitate which redissolves) and diluted to 250 ml 15 with water. This Mn—Ti solution was fed into the alumina slurry at ca. 10 ml min⁻¹. Ammonia solution (100 ml diluted to 333 ml) was added at a variable rate with the pH control unit set at 7.8, such that the pH during the experiment was kept within the pH 7.6-8.0 range. The material was collected by filtration and washed and re-slurried until the conductivity of the final filtrate washings was <100 μScm⁻¹.

XRD: alumina major phase with amorphous manganese oxide and titanic BET surface area dried at 350° C. for 4 hours=290.1 m²/g; Total pore volume 0.646 ml g⁻¹; BJH Av. Pore size 8.82 nm (Micromeritics Tristar instrument).

### EXAMPLE 2

### Supported Amorphous Mn:Ti 85:15

This material was prepared in a similar manner to Example 1, except in that 152.0 g, 0.425 mol manganese nitrate 50% w/w solution and 15 ml, 0.075 mol titanium oxychloride were used.

XRD: alumina major phase with amorphous manganese oxide and titanic

BET surface area dried at 350° C. for 4 hours=303.2 m²/g; Total pore volume 0.581 ml g⁻¹; BJH Av. Pore size 7.24 nin (Micromeritics Tristar instrument).

### EXAMPLE 3

### Supported Amorphous Mn:ZR 85:15

This material was prepared in a similar manner to Example 1, except in that the mixture contained 152.0 g, 0.425 mol manganese nitrate 50% w/w solution and 34 ml, 0.075 mol of zirconyl nitrate (273 g/l) was used instead of the titanium oxychloride.

XRD: alumina major phase with amorphous manganese oxide and zirconia

BET surface area dried at 350° C. for 4 hours=315.2 m²/g; Total pore volume 0.602 ml g⁻¹; BJH Av. Pore size 7.66 nm (Micromeritics Tristar instrument).

### EXAMPLE 4a

### Supported Amorphous Manganese Oxide

Manganese nitrate (118 g, 50% w/w solution, 0.332 mol) was diluted to 180 ml and fed into an overhead stirred slurry of jet-milled gamma alumina (1) (82 g) in 500 ml water. The 2 L beaker containing slurry was fitted with a pH probe and pH control unit. The rate of addition of the manganese nitrate was ca. 10 ml min⁻¹. Ammonia solution (ca 4.5 M) was co-fed into the slurry with the aim of pH control at 7.8. Actual pH 8.2-8.5 throughout most of the addition. Final pH ca. 8.1. The material was collected by filtration and washed and re-slurried until the conductivity of the final filtrate washings was <100 μScm⁻¹.

XRD: alumina major phase with amorphous manganese oxide.

BET surface area dried at 350° C. for 4 hours=305.6 m²/g; Total pore volume 0.522 ml g⁻¹; BJH Av. Pore size 6.30 nm (Micromeritics Tristar instrument).

### EXAMPLE 4b

### Supported Amorphous Manganese Oxide

A second material was prepared in a similar manner to the Example 4a material except that manganese nitrate (197 g, 0.5 mol 50 wt % solution) and Ammonia (80 ml diluted to 333 ml, ca 3.6 M) were used The pH was kept at 8.25-8.4 throughout, and the final pH was 8.3.

XRD: alumina major phase with amorphous manganese oxide.

BET surface area dried at 350° C. for 4 hours=303.0 m²/g; Total pore volume 0.524 ml g⁻¹; BJH Av. Pore size 6.43 nm (Micromeritics Tristar instrument).

### EXAMPLE 5

### Supported Amorphous Active Manganese Oxide

### Manganese Acetate/Acetic Acid—Potassium Permanganate Route

Chemicals KMnO₄
   Manganese acetate tetrahydrate
   Glacial acetic acid
   Jet-milled high surface area gamma alumina (1)
   Deionised water
1) A solution of 19.8 g (0.125 mol) potassium permanganate in 288 ml deionised water was prepared. 50.0 g jet-milled gamma alumina (1) was added to this saturated solution and the resulting slurry gradually heated to 60-70° C. with stirring.
2) An acetic acid solution was prepared by diluting 45.0 g glacial acetic acid in 375 ml deionised water. Subsequently 57.4 g of this acidified solution was removed, before 43.8 g (0.18 mol) manganese acetate tetrahydrate was added to it. This resulting Mn acetate/acetic acid solution was gradually heated to ca. 60° C., with stirring.
3) The hot Mn acetate/acetic acid solution was added to the hot KMnO₄/alumina slurry drop-wise over a period of 60 minutes, with continuous stirring and heating. The temperature after the final addition was 81° C. and the solution had a pH of 3.8. After the final Mn acetate/acetic acid addition the slurry was heated with stirring to ca. 90° C. over 15 minutes, before being quenched by the addition of 600 ml deionised water. The temperature after quenching was 55° C.
4) The resulting brown slurry was recovered by Büchner filtration and washed with copious amounts of deionised water. The conductivity of the final filtrate washings was 582 μScm⁻¹ [deionised water reference=6 μScm⁻¹]. The precipitate residue was dried in an oven at 100° C., though the raw catalyst material was taken from the wet cake residue product (not the dry agglomerated powder).

XRD analysis of the Example 5 material showed that the supported manganese oxide material was amorphous and this was confirmed by scanning transmission electron microscopy (STEM) measurements using a High Angle Annular Dark Field (HAADF) Detector.

BET surface area dried at 350° C. for 4 hours=331.0 m²/g; Total pore volume 0.689 ml g⁻¹; BJH Av. Pore size 7.18 nm (Micromeritics Tristar instrument).

### EXAMPLE 6

### Supported Amorphous Active Manganese Oxide Manganese Sulfate/Acetic Acid—Potassium Permanganate Route

Chemicals KMnO₄
   Manganese sulfate monohydrate
   Glacial acetic acid
   Deionised water
Choice of support from: Jet-milled high surface area gamma alumina (1) (Example 6a);
   Jet-milled high surface area gamma alumina (2) (Example 6b)
   Beta-zeolite (Example 6c)
   Zirconia-titania mixed oxide (Example 6d)
1) A solution of 29.6 g (0.187 mol) potassium permanganate in 432 ml deionised water was prepared. 75.0 g of the support was added to this saturated solution and the resulting slurry was gradually heated to 60-70° C. with stirring.
2) An acetic acid solution was prepared by diluting 66.0 g glacial acetic acid in 477 ml deionised water. Subsequently 45.5 g (0.269 mol) manganese sulfate monohydrate was added to it. This resulting Mn sulfate/acetic acid solution was gradually heated to ca. 60-C, with stirring.
3) The hot Mn sulfate/acetic acid solution was added to the hot KMnO₄/support slurry drop-wise over a period of 60 minutes, with continuous stirring and heating. The temperature after the final addition was ca. 80° C. and the solution had a pH of 3.8. After the final Mn sulfate/acetic acid addition, the slurry was heated with stirring to ca. 90° C. over 15 minutes, before being quenched by the addition of ca. 1000 ml deionised water. The temperature after quenching was 50° C.
4) The resulting brown slurry was recovered by Büchner filtration and washed with copious amounts of deionised water. The conductivity of the final filtrate washings was 56 μScm⁻¹ [deionised water reference=6 μScm⁻¹]. The precipitate residue was dried in an oven at 100° C., though the raw catalyst material was taken from the wet cake residue product (not the dry agglomerated powder).
   Analysis—Example 6a

XRD: alumina major phase with amorphous manganese oxide.

BET surface area for the Example 6a material dried at 350° C. for 4 hours=313.6 m²/g; Total pore volume 0.531 ml g⁻¹; BJH Av. Pore size 7.66 nm (Micromeritics Tristar instrument). By comparison, for the jet-milled gamma alumina (1) per se: BET surface area dried at 350° C. for 4 hours=286.2 m²/g; Total pore volume 0.570 ml g⁻¹; BJH Av. Pore size 6.82 nm (Micromeritics Tristar instrument).

Analysis—Example 6b

XRD: alumina major phase with amorphous manganese oxide.

BET surface area for the Example 6b material dried at 350° C. for 4 hours=245.6 m²/g; Total pore volume 0.567 ml g⁻¹; BJH Av. Pore size 9.32 nm (Micromeritics Tristar instrument). By comparison, for the jet-milled gamma alumina (2) per se: BET surface area dried at 350° C. for 4 hours=186.6 m²/g; Total pore volume 0.545 ml gel; BJH Av. Pore size 9.60 nm (Micromeritics Tristar instrument).

Analysis—Example 6c

XRD: alumina major phase with amorphous manganese oxide.

BET surface area for the Example 6c material dried at 350° C. for 4 hours=475.8 m²/g; Total pore volume 0.764 ml gel; BJH Av. Pore size 15.73 nm (Micromeritics Tristar instrument). By comparison, for the Beta-zeolite per se: BET surface area dried at 350° C. for 4 hours=618.3 m²/g; Total pore volume 0.710 ml g⁻¹; BJH Av. Pore size 12.72 nm (Micromeritics Tristar instrument).

Analysis—Example 6d

XRD: alumina major phase with amorphous manganese oxide.

BET surface area for the Example 6d material dried at 350° C. for 4 hours=351.1 m²/g; Total pore volume 0.384 ml g⁻¹; BJH Av. Pore size 5.81 nm (Micromeritics Tristar instrument). By comparison, for the zirconia-titania mixed oxide per se: BET surface area dried at 350° C. for 4 hours=329.4 m²/g; Total pore volume 0.322 ml gel; BJH Av. Pore size 5.53 nm (Micromeritics Tristar instrument).

### EXAMPLE 7

### Supported Amorphous Active Manganese Oxide Manganese Nitrate/Acetic Acid—Potassium Permanganate Route

Chemicals KMnO₄
   Manganese nitrate hexahydrate
   Glacial acetic acid
   Jet milled high surface area gamma alumina (1)
   Deionised water
5) A solution of 29.6 g (0.187 mol) potassium permanganate in 431 ml deionised water was prepared. 75.0 g jet milled gamma alumina was added to this saturated solution and the resulting slurry gradually heated to ca. 70° C. with string.
6) An acetic acid solution was prepared by diluting 65.3 g glacial acetic acid in 476 ml deionised water. Subsequently 77.2 g (0.267 mol) manganese nitrate hexahydrate was added to this acidified solution. This resulting Mn nitrate/acetic acid solution was gradually heated to ca. 60° C., with stirring.

7) The hot Mn nitrate/acetic acid solution was added to the hot KMnO₄/alumina slurry drop-wise over a period of 40 minutes, with continuous stirring and heating. The temperature after the final addition was 71° C. After the final Mn nitrate/acetic acid addition the slurry was heated with stirring to ca. 90° C. over 15 minutes, before being quenched by the addition of 1200 ml deionised water. The temperature after quenching was 49° C., and the slurry had a pH of 2.1.
8) The resulting brown slurry was recovered by Büchner filtration and washed with copious amounts of deionised water. The conductivity of the final filtrate washings was 45 μScm⁻¹ [deionised water reference=5 μScm⁻¹]. The precipitate residue was dried in an oven at 100° C., though the raw catalyst material was taken from the wet cake residue product (not the dry agglomerated powder).
   XRD: alumina major phase with amorphous manganese oxide.

BET surface area dried at 350° C. for 4 hours=308.4 m²/g; Total pore volume 0.584 ml g⁻¹; BJH Av. Pore size 7.12 nm (Micromeritics Tristar instrument). By comparison, the jet milled gamma alumina: BET surface area dried at 350° C. for 4 hours=286.2 m²/g; Total pore volume 0.570 ml gel; BJH Av. Pore size 6.82 nm (Micromeritics Tristar instrument).

### EXAMPLE 8

### Mn:Ti 66:33

Whilst the “bulk”, i.e. non-supported, materials disclosed in Examples 8 and 9 do not fall within the claims, they are included to illustrate how changing the Mn:Ti ratio affects ozone decomposition activity.

Titanium oxychloride (69 ml, 0.334 mol, [388 g/L TiO₂]) was added to a solution of manganese nitrate (190.8 g, 0.664 mol) in water (500 ml). This mixed feed was added rapidly to over head stirred ammonia solution (200 ml, 3 mol) diluted to 1 L. After 10 mins string the volume was made up to 4 L and the material was then decant washed until the conductivity was 400 μScm⁻¹. The material was then collected by filtration and washed on the filter bed until the conductivity of the filtrate was below 100 μScm⁻¹. The material was then oven dried at 100° C.

XRD: largely Mn₃O₄ and amorphous titania

BET surface area dried at 350° C. for 4 hours=183.3 m²/g; Total pore volume 0.357 ml g⁻¹; BJH Av. Pore size 8.17 nm (Micromeritics Tristar instrument).

### EXAMPLE 9

### Mn:Ti 85:15

A manganese nitrate solution (156 g, 15 wt % Mn, 0.425 mol Mn, 48.7 wt % Mn(NO₃)₂ in dilute HNO₃) was added to titanium oxychloride (15.2 ml, 0.075 mol, [396 g/L TiO₂]) and the volume was made up to Ca. 250 ml.

This solution was added rapidly to overhead stirred ammonia solution (100 ml, 1.5 mol) diluted to 500 ml. The yellowy precipitate slurry was stirred for 10 minutes and then filtered and washed on the filter bed until the conductivity was <100 μScm⁻¹. The material was dried under suction and then redispersed in ca. 200 ml EtOH, stirred for 10 minutes and then filtered. The material was then oven dried at 100° C.

XRD: largely Mn₃O₄ and amorphous titania.

BET surface area dried at 350° C. for 4 hours=103.3 m²/g; Total pore volume 0.275 ml g⁻¹; BJH Av. Pore size 11.37 nm (Micromeritics Tristar instrument).

### COMPARATIVE EXAMPLE 1

A material—described as high surface area cryptomelane—was manufactured in accordance with the method described in Example 23 of WO 96/22146 and was found to have the following characteristics: BET surface area dried at 350° C. for 4 hours=140.3 m²/g; Total pore volume 0.448 ml g⁻¹; BJH Av. Pore size 12.84 nm (Micromeritics Tristar instrument). The material in Example 23 is described as having a BET Multi-Point surface area of 296 m²/g after oven drying at 100° C.

XRD: poorly ordered cryptomelane KMn₈O₁₆.

### COMPARATIVE EXAMPLE 2

### Mn:Zr 85:15

Manganese nitrate hydrate (121.76 g, 0.425 mol) and zirconyl nitrate (33.6 ml, 275 g/L ZrO₂, 0.075 mol) were dissolved in water and diluted to 400 ml. This solution was added over 1-2 min to overhead stirred ammonia solution (150 ml, 2.25 mol diluted to 500 ml). The precipitate slurry was stirred for 30 min and then water was added to make the volume up to 2.5 L. The precipitate was decant washed and then dried at 100° C. and then fired at 35° C. for 2 hours (ramp up and down 10° C./min).

XRD analysis showed that the material contains a mixture of the Mn₅O₈ phase (major), the Mn₃O₄ phase (minor) and amorphous zirconia.

BET surface area dried at 350° C. for 4 hours=95.0 m²/g; Total pore volume 0.233 ml g¹; BJH Av. Pore size 11.99 nm (Micromeritics Tristar instrument).

### EXAMPLE 10

### Catalyst Composition Comprising Catalyst and Binder

Materials: Catalysts prepared according to Examples 1 to 8 and Comparative Examples 1 and 2 as a water-based slurry at known solids;
   demineralised water; and
   adhesive binder EP1 or EN1020 (both Air Products-Wacker Chemie—aqueous, plasticiser-free, self cross linking polymer dispersion of a copolymer of vinyl acetate and ethylene) at approximately 50% solids. Binder EP1 was used for Examples 1-6 and Comparative Example 2, the remaining Examples used EN1020.
(i) Weigh the mixing bowl.
(ii) Add 20 g dry solids catalytic material obtained according to Examples above. However the material is typically kept as a water-based wet cake to prevent particle agglomeration during drying, thus the amount of catalytic material slurry required needs to be calculated.
(iii) Add any additional demineralised water needed to obtain a final slurry of ca. 20% solids—a level suitable for spray coating.
(iv) Add 10 g dry solids EP1 binder, again this is usually a water-based slurry at 50% solids, and thus 20 g EP1 slurry is needed to give a final catalyst:binder 2:1 solids ratio by weight.
(v) Mix to form an homogeneous slurry (ca. 10 min) before spray coating.

### EXAMPLE 11

### Catalyst Testing

The compositions of Example 10 were spray coated as a spot of defined area on both sides of a Volvo 850 aluminium radiator (Valeo part#8601353) using a gravity fed, compressed air spray gun (Devilbiss) and dried in air at <150° C. to drive off water and cross link the binder within the coating to ensure adhesion to the substrate and cohesion within the coating. Coating and drying were repeated until a final loading of approximately 0.50 g in⁻³ was obtained. The coated radiator spots were tested in an apparatus developed in-house. The radiator tanks were connected to a hot water circulator and the coated radiator spot was located in the flow path of a purpose built rig. Ozone was generated in a generator (Hampden Test Equipment) and passed over the coated radiator spot at a selected flow rate to mimic the flow of ambient air over a vehicle radiator mounted in an engine compartment at various vehicle speeds. Ozone content in gas was detected both upstream and downstream of the radiator spot using Dasibi (Dasibi Environmental Corp. UV Photometric Ozone analyser Model 1008-AH) and Horiba (Ambient Ozone monitor APOA-360) analysers.

Results plotted in FIG. 1 show that the Example 1 material is at least as active for ozone decomposition as the Comparative Example 1 material. Also, supported catalysts (Examples 1 and 2) are more active than the corresponding “bulk” materials (Example 8 and 9). It can be seen that the Example 2 material is slightly less active at the higher temperatures tested compared with the Example 1 material and this replicates the trend seen in the “bulk” materials shown in FIG. 1. Since it would be expected from the results shown in FIG. 4 that increasing the amount of manganese in the supported amorphous oxide would increase the activity of the resulting catalyst (compare the activity of the Example 4a and 4b materials), it is surprising that in the case of the amorphous metal oxide containing manganese and titanium, this trend is reversed. Accordingly, this observation indicates that a synergy exists between manganese and titanium in this embodiment of the invention, for reasons that are as yet unclear.

Referring to FIG. 2, it can be seen that, of the supported amorphous metal oxide materials prepared by comproportionation from a manganous salt and a permanganate salt (Examples 5, 6a and 7), the Example 7 material, made with manganous nitrate is less active, whilst the activity of the Example 5 and 6a materials is similar to one another.

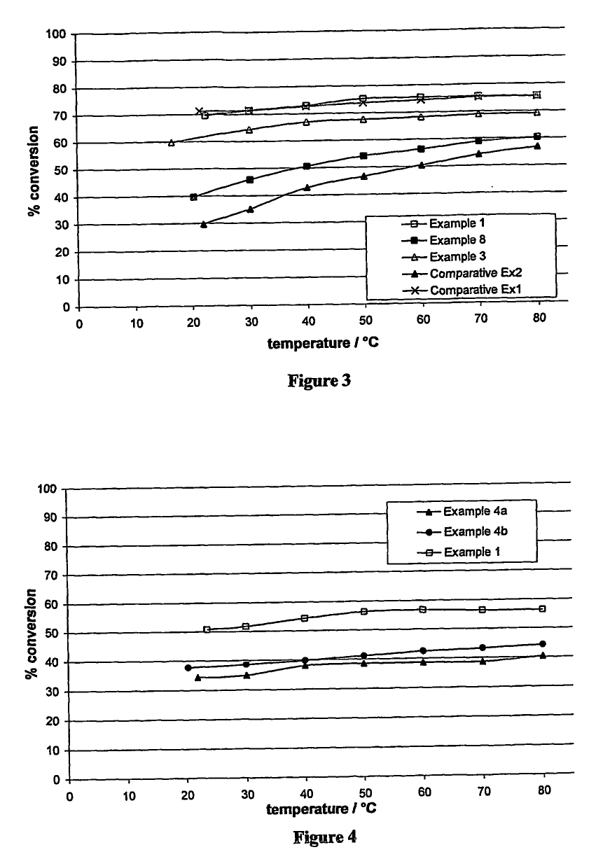

From FIG. 3, it can be seen that the Mn:Zr 85:15 supported material of Example 3 is more active than the corresponding “bulk” material of Comparative Example 2, which is less active than the “bulk” Mn:Ti 66:33 material of Example 8. The trend in activity between the “bulk” materials is repeated with the corresponding supported materials.

FIG. 5 shows that the choice of support can affect the activity of the resulting catalyst. It can be seen, for Example, that activity can be increased by use of a different gamma-alumina support, or by choosing a zeolite or alternative metal oxide support Indeed, the ozone decomposition activity of these materials is similar or better than the Comparative Example 1 catalyst material.

### EXAMPLE 12

### X-Ray Diffraction

Each of FIGS. 6 to 11 contain two X-ray diffraction patterns and in all Figures these two patterns are plotted with the same offset. To allow comparison, all the XRD Figures have the same Y-axis scale, though within each graph the two patterns are scaled to the same major peak height. All plots run from 15-90 °2 theta, any intensity around 15° is due to the bare sample holder and as such should be discounted.

The absence of a series of additional peaks in the XRD patterns for the support material plus the supported metal oxide compared with the support material per se indicates that the supported metal oxide material is amorphous.

### EXAMPLE 13

### Transmission Electron Microscopy (TEM)

Referring to FIG. 12a, within the Example 1 material, alumina-rich and Mn:Ti-rich areas were identified. The alumina-rich areas possess a needle-like particle morphology, characteristic of γ-alumina, which is present throughout the sample. In some cases these needles project beyond the surface of the particle clusters. The Mn:Ti-rich areas, by contrast, consist of dense agglomerations of particles. Within these manganese-rich regions there is no evidence of pores of any size/shape>5 nm; compare to the 10 nm scale bar in FIG. 12a Scanning Transmission Electron Microscope (STEM) examination of the Mn:Ti-rich regions as resin-mounted sections (results not shown) indicate that both the Mn and Ti components are associated, being located in the same area and evenly concentrated together. These regions may or may not correspond to the presence of alumina.

Whilst examining this sample it was seen that the material in the line of the electron beam altered over a period of time. Comparing the Bright Field TEM images and their associated Fast Fourier Transform (FFT) electron diffraction patterns (FFT electron diffraction pattern for FIG. 12a shown in FIG. 12b), initially no electron diffraction spots were observed, but electron diffraction rings developed around the centre spot over time. Later electron diffraction patterns (not shown) showed the beginnings of discrete spots due to wide-angle diffraction, i.e. the initial absence of FFT diffraction spots indicates that the as-prepared material is non-crystalline. Thus we consider that the Mn:Ti-rich areas are amorphous.

Referring to FIG. 13a, again needle-like morphology, characteristic of γ-alumina, was observed throughout the sample of the Example 3 material. Two further morphologies: flat plate-like and frogspawn-like were also identified. These three regions were examined in STEM mode, where the line scans (results not shown) suggest that the Mn-containing areas are most closely associated with the alumina component (though this correlation is weak) and least prevalent in the frogspawn like morphology. High Angle Annular Dark Field (HAADF)-Energy Dispersive X-ray (EDX) data (not shown) indicates that the Zr component is low throughout Similarly to the analysis of the Example 1 material, no distinctive (e.g. >5 nm) pore structure was identified within the Mn-containing regions. Additionally the Example 3 material was found to be unstable in the electron beam: the FFT electron diffraction patterns showing increasing crystallinity over the four-minute examination period (results not shown). This demonstrates that the fresh sample was amorphous at the time of the initial examination. The FFT electron diffraction pattern of the fresh material is shown in FIG. 13b.

1. A method of making an ozone decomposition catalyst comprising an amorphous metal oxide consisting of manganese and, optionally, one or more of zirconium, silicon, titanium and aluminium, on a particulate support material, which method comprising the steps of preparing a mixture comprising an aqueous manganese salt and the support material and co-precipitating the metal oxide onto the support material.

2. A method according to claim 1, wherein the amorphous manganese oxide is obtainable by comproportionation of at least two oxidation states of manganese.

3. A co-method according to claim 1 or 2, comprising mixing a first aqueous solution of a permanganate salt and a second aqueous solution of a manganous salt, wherein the support material is in either the first solution or the second solution or both.

4. A method according to claim 3, wherein the first solution or the second solution or both contains a soluble base material.

5. A method according to claim 4, wherein the soluble base material is potassium, hydroxide, sodium hydroxide or a tetra-alkyl ammonium hydroxide.

6. A method according to claim 3, wherein the first solution and/or the second solution contains an acid.

7. A method according to claim 6, wherein the acid is sulfuric acid, nitric acid, hydrochloric acid or a carboxylic acid, preferably acetic acid.

8. A method according to any of claims 3 to 7, wherein the manganous salt is manganese chloride (MnCl₂), manganese nitrate (Mn(NO₃)₂), manganese sulfate (MnSO₄), manganese perchlorate or a manganese carboxylate, preferably manganese acetate (Mn(CH₃COO)₂), or a mixture of any two or more thereof.

9. A method according to any of claims 3 to 8, wherein the permanganate salt is a salt of an alkali metal or an alkaline earth metal.

10. A method according to claim 9, wherein the permanganate salt is a salt of sodium, potassium, caesium, magnesium, calcium or barium or a mixture of any two or more thereof.

11. A method according to claim 1, wherein the amorphous metal oxide comprises at least 50 mole % manganese.

12. A method according to claim 11, wherein the amorphous metal oxide comprises 50-95 mole % manganese, optionally from 60-75 mole % manganese.

13. A method according to claim 11 or 12, wherein the oxide material comprises Mn85:Zr15, Mn85:Ti15, Mn66:Ti33 or Mn85:Al15, based on the number of moles of manganese.

14. A method according to any preceding claim, wherein the manganese in the oxide material is present in the +3 oxidation state.

15. A method according to any preceding claim, wherein the support material is alumina, silica, zirconia, titania, ceria, chromia or a mixture, mixed oxide or composite oxide of any two or more thereof.

16. A method according to claim 15, wherein the alumina is gamma, delta or theta alumina.

17. A method according to claim 15 or 16, wherein the support material is doped with at least one of lanthanum, barium, cerium, aluminium, titanium, tungsten, silica and manganese.

18. A method according to any of claims 1 to 14, wherein the support material is boehmite (aluminium hydroxide).

19. A method according to any of claims 1 to 14, wherein the support material is activated carbon.

20. A method according to any of claims 1 to 14, wherein the support material is at least one molecular sieve selected from the group consisting of zeolites, hydrotalcites, silica-based mesoporous materials, iron oxide-based mesoporous materials, aluminium phosphonates, ion exchange resins and mixtures of any two or more thereof.

21. A method according to claim 20, wherein the zeolite is ZSM-5, Y-zeolite or β-zeolite.

22. A method according to any of claims 1 to 14, wherein the support is an amorphous silica-alumina, a silica-zirconia, alumina-zirconia, alumina-chromia, alumina-ceria, ceria-titania, manganese-zirconia, manganese-alumina, manganese-silica, manganese-titania or a ternary or quaternary oxide material comprising manganese and at least two of zirconium, aluminium, silicon and titanium and mixtures of any two or more thereof.

23. A method according to claim 22, wherein the amorphous silica-alumina and silica-zirconia support comprises from 1% to 35% by weight of silica and from 65% to 99% by weight of M, wherein M is alumina or zirconia.

24. A method according to claim 21, wherein the manganese-containing support materials comprise at least 50 mole % manganese, preferably 50-95 mole % manganese.

25. A method according to any preceding claim, wherein the surface area of the support material is from 50 to 700 m²/g, optionally from 100 to 450 m²/g and preferably from 150 to 400 m²/g.

26. A method according to any preceding claim, wherein the particle size D90 of the support is from 0.1 to 50 μm, such as 0.1-20 μm or 0.1-10 μm.

27. An ozone decomposition catalyst obtainable by a method according to any preceding claim

28. A catalyst according to claim 27, comprising at least one precious metal.

29. A catalyst according to claim 28, wherein the or each at least one precious metal is selected from platinum group metals, silver and gold.

30. A catalyst according to claim 29, wherein the or each at least one platinum group metal is selected from platinum, palladium and rhodium, and is preferably platinum or palladium.

31. A catalyst according to claim 30, comprising 0.1-20 wt % total precious metal.

32. A catalyst according to claim 31, comprising 0.5-15 wt %, preferably 2-5 wt % total precious metal.

33. A catalyst according to any of claims 28 to 32, comprising at least one promoter selected from copper, iron, zinc, chromium, nickel, cobalt and cerium on the support material.

34. A catalyst composition comprising a catalyst according to any of claims 27 to 33 and a binder.

35. A catalyst composition according to claim 34, wherein the binder is inorganic, preferably silicate-based, alumina-based or ammonium zirconium carbonate-based.

36. A catalyst composition according to claim 34, wherein the binder is polyethylene, polypropylene, a polyolefin copolymer, polyisoprene, a polybutadiene copolymer, chlorinated rubber, nitrile rubber, polychloroprene, an ethylene-propylene-diene elastomer, polystyrene, polyacrylate, polymethacrylate, polyacrylonitrile, a poly(vinyl ester), a poly(vinyl halide), a polyamide, an acrylic, a vinyl acrylic, an ethylene vinyl acetate copolymer, a styrene acrylic, a poly vinyl alcohol, a thermoplastic polyester, a thermosetting polyester, a poly(phenyleneoxide), a poly(phenylene sulfide), a fluorinated polymer, a poly(tetrafluoroethylene), polyvinylidene fluoride, poly(vinylfluoride), a chloro/fluoro copolymer, ethylene, a chlorotrifluoroethylene copolymer, a polyamide, a phenolic resin, an epoxy resins, polyurethane, a silicone polymer or a mixture of any two or more thereof.

37. A catalyst composition according to claim 34, 35 or 36, wherein the weight ratio of catalyst:binder is from 15:1 to 1:5, preferably from 10:1 to 1:1.

38. An atmosphere-contacting surface coated with a catalyst composition according to any of claims 34 to 37.

39. An atmosphere contacting surface according to claim 38, comprising a heat exchanger, a fan blade, a fan grill or a conduit for conveying a fluid.

40. An atmosphere contacting surface according to claim 39, wherein the heat exchanger comprises a radiator, an air charge cooler, an air conditioner condenser, an engine oil cooler, a power steering oil cooler or a transmission oil cooler.

41. A vehicle or a non vehicular device comprising an atmosphere contacting surface according to claim 38, 39 or 40.

42. A non-vehicular device according to claim 41 comprising an air conditioning system for a building or a moving advertising hoarding.

43. A non-vehicular device according to claim 41, which is a powered tool, optionally a lawnmower, a cutter, a strimmer, a disk saw, a chain saw or a leaf blower/collector.

44. A method of decomposing ozone, which method comprising contacting a fluid containing the ozone with a catalyst according to any of claims 27 to 33, preferably at up to 150° C.

45. A method according to claim 43, wherein the fluid is atmospheric air.
